(19) United States
(12) Patent Application Publication
(10) Pub. No.: US 2013/0190030 A1
(43) Pub. Date: Jul. 25, 2013

(54) A Method of Allocating Resources in a Radio Access Network (RAN) Shared by Different Network Operators

(71) Applicants: Harri Kalevi Holma, Helsinki (FI); Jussi Petteri Reunanen, Bangkok (TH)

(72) Inventors: Harri Kalevi Holma, Helsinki (FI); Jussi Petteri Reunanen, Bangkok (TH)

(73) Assignee: Nokia Siemena Networks Oy, Espoo (FI)

(21) Appl. No.: 13/812,296

(22) PCT Filed: Jul. 28, 2010
(86) PCT No.: PCT/EP10/60979

§ 371 Date: Mar. 18, 2013

(51) Int. Cl. H04W 72/04

(52) U.S. Cl. CPC H04W 72/0493
USPC 455/509

(57) ABSTRACT

A method of allocating resources in a communications network is provided, where the resources are allocated to mobile stations belonging to different network operators. It is determined whether capacity is available in the network for established connections between the mobile stations and the communications network. If it is determined that the capacity is not available for the established connections, the resources are split according to a pre-determined share between the network operators.

### FIELD OF THE INVENTION

The invention generally relates to a method of allocating resources in a communications network. More particularly, the invention relates to a method of allocating resources in a radio access network (RAN) to mobile stations subscribing to different network operators.

### BACKGROUND OF THE INVENTION

In certain countries, for example India, not all operators of mobile communications networks have full use of the nationwide radio frequency spectrum. For example, the 3G spectrum at 2.1 GHz was auctioned in 2010 in India but none of that country's 3G network operators can offer a nationwide frequency spectrum to their users.

However, the network operators still want to offer their services nationwide. Therefore network operators have to share a radio access network (RAN). If cell resources are in short supply (for example if the traffic load is high) a network operator needs to ensure that its own subscribers have access to the RAN network resources, regardless of the number of users in the cell.

Multi-operator RAN uses dedicated frequencies per operator. In this case, ensuring users have access to all network resources is not a problem. This solution is not possible in countries where the number of frequencies is very limited however.

Proportionally fair scheduling is a scheduling algorithm, which attempts to maximize total wireless network throughput, while allowing all users at least a minimal level of service. However, this solution schedules traffic between users; not between groups of users (e.g., those subscribing to operator A and those subscribing to operator B).

EP2190249A2 discloses a method for obtaining Quality of Service (QoS) differentiation in RAN sharing, wherein different operators share the radio network resources. Each operator has its own QoS mapping tables for differentiating user priority levels according to a plurality of parameters. A PLMN-id parameter indicating the operator selected by the user is obtained from each user accessing the shared network. The priority level of the user according to the PLMN-id parameter and the QoS mapping table of the selected operator are then obtained.

This method allows only users subscribing to the same network operator to be differentiated and does not allow resources to be allocated to different network operators.

Therefore a method is required, which allows RAN resources to be fairly allocated between users of different network operators.

### SUMMARY OF THE INVENTION

Accordingly, the invention provides a method of allocating resources in a communications network to mobile stations belonging to a group. It is determined whether capacity is available in the network for established connections between the mobile stations and the communications network. If it is determined that capacity is not available for the established connections between the mobile stations and the network, the resources are split according to a pre-determined share such that the established connections receive this pre-determined share of the resources.

In other words, the network resources may be split between groups in both the uplink and the downlink so that each group may use a share of the total network resources. In this way, in a case where a particular group does not have use of the full capacity of the communications network, it is still able to use the resources of the network. However, this also allows for full trunking gain, whereby if mobile stations belonging to only one group are using data services in the network, the full network capacity can be allocated to that single group.

The group to which the mobile stations belong could be subscribed to a particular network operator or could include roaming users of the part of the communications network operated by a particular network operator. Therefore, where the network operator has not been allocated a full nationwide frequency spectrum for the communications network, the network operator is still able to offer its services to its subscribers nationwide by always having a pre-determined share of network resources. Furthermore, this allows for operator-specific QoS algorithms to be used independently of other operators.

Preferably, the resources are split according to the pre-determined share on an interface between two nodes of the network. This could be the Iub interface, for example between a base station (NodeB) and base station controller (radio network controller (RNC)). In this case, the pre-determined share of the resources may correspond to a pre-defined split in interface throughput and can be determined according to a flow control algorithm. No change is required to existing network nodes (e.g. NodeB and RNC) in this case, since the network nodes can already identify the group (e.g. network operator) to which each established connection between mobile station and network belongs (for example, in the RNC, this information is already available after handover). Only the flow control unit in the RNC is required to be changed—no changes are required to the NodeB. The flow control algorithm can be extended to multiple operators and have a separate roaming user category.

The pre-determined share of the resources may also be determined according to whether an amount of data to be sent to the mobile stations has been buffered in a network node. For example, for those network operators having data in the buffer of the NodeB for a particular TTI, the resources can be shared proportionally between operators according to the amount of data buffered for each operator. If only one operator has data in the buffer, then that operator's users can use the full RAN capacity. In these cases, the pre-determined share of the resources can be split in the network node (NodeB). This allows resources to be shared on both the air interface and the Iub interface.

On the other hand, if an operator runs out of credits, that particular operator can receive a pre-determined share of the resources, for example according to a pre-defined split in Iub interface flow control.

In one embodiment, the pre-determined share of the resources corresponds to a share in data throughput in the network.

This can take place so that the step of splitting involves either limiting the throughput per group in a control node of the network or limiting the throughput per group in a core network part of the network. This means that there could be a throughput limit per operator in the RNC; i.e., a maximum data rate per operator RNC wide. The RNC must then calculate the total throughput per IMSI or per core network (MOON). Alternatively, there could be a throughput limit per operator in the core network; i.e., a maximum data rate per circle. This throughput limit could be estimated from capacity equations and agreed between network operators.

The invention further provides a control node for a communications network. The control node includes a processor configured to determine whether capacity is available in the network for established connections between mobile stations belonging to a group and the communications network. The processor is further configured to split a pre-determined share of resources and give the pre-determined share to the established connections between the mobile stations and the network if it determines that the capacity is not available for these established connections.

The control node can be an RNC so that the processor splits the pre-determined share of resources is split over an Iub interface between the RNC and a NodeB. A flow control unit may further be included in the control node, which is configured to control a flow control over an interface between the control node and another network node such that the pre-determined share of the resources to the established connections corresponds to a split in interface throughput. The processor may be further configured to calculate the pre-determined share of the resources using a control algorithm. In this way, the processor can be an existing flow control unit (e.g. Iub interface flow control unit) in the RNC configured to run a control algorithm, which can be easily extended to multiple operators and separate roaming users.

The invention will now be described, by way of example only, with reference to specific embodiments, and to the accompanying drawings, in which:

### BRIEF DESCRIPTION OF THE DRAWINGS

FIG. 1 is a simplified schematic block diagram of a wireless communications network in which the method according to an embodiment of the invention may be implemented; and

FIG. 2 is a flow chart illustrating the method according to an embodiment of the invention.

### DETAILED DESCRIPTION OF EXEMPLARY EMBODIMENTS

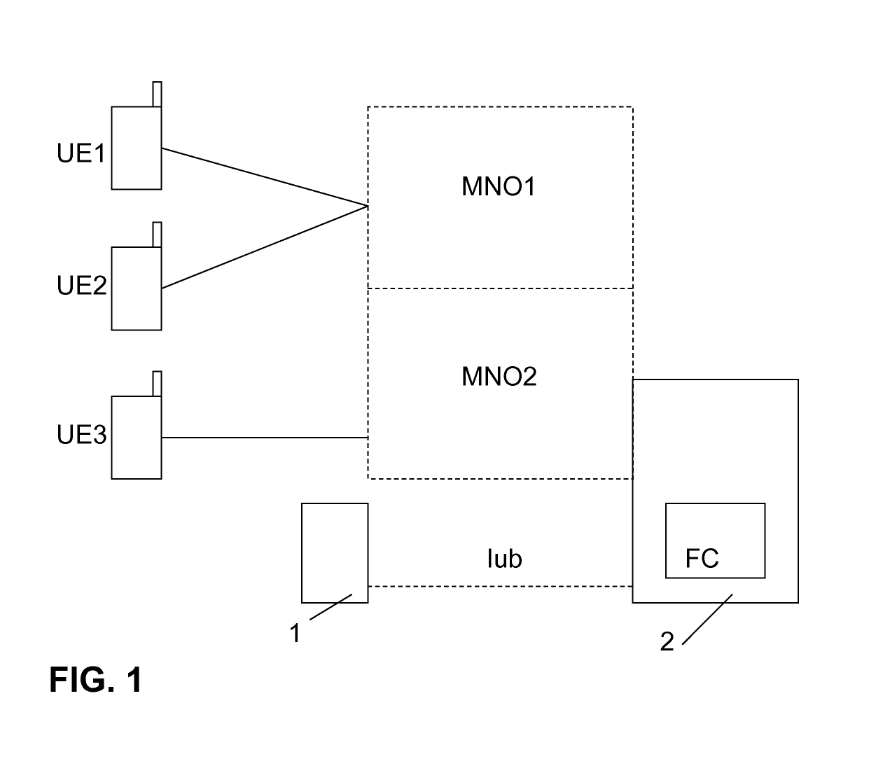

FIG. 1 shows a radio access network (RAN) part of a communications network having a base station or NodeB 1 controlled by a radio network controller (RNC) 2 over an Iub interface. Mobile stations UE1, UE2 and UE3 can access the RAN over an air interface via the NodeB 1.

The RNC 2 has a flow control unit FC, which includes a processor for running a flow control algorithm. The RNC is coupled to the core network part of the communications network.

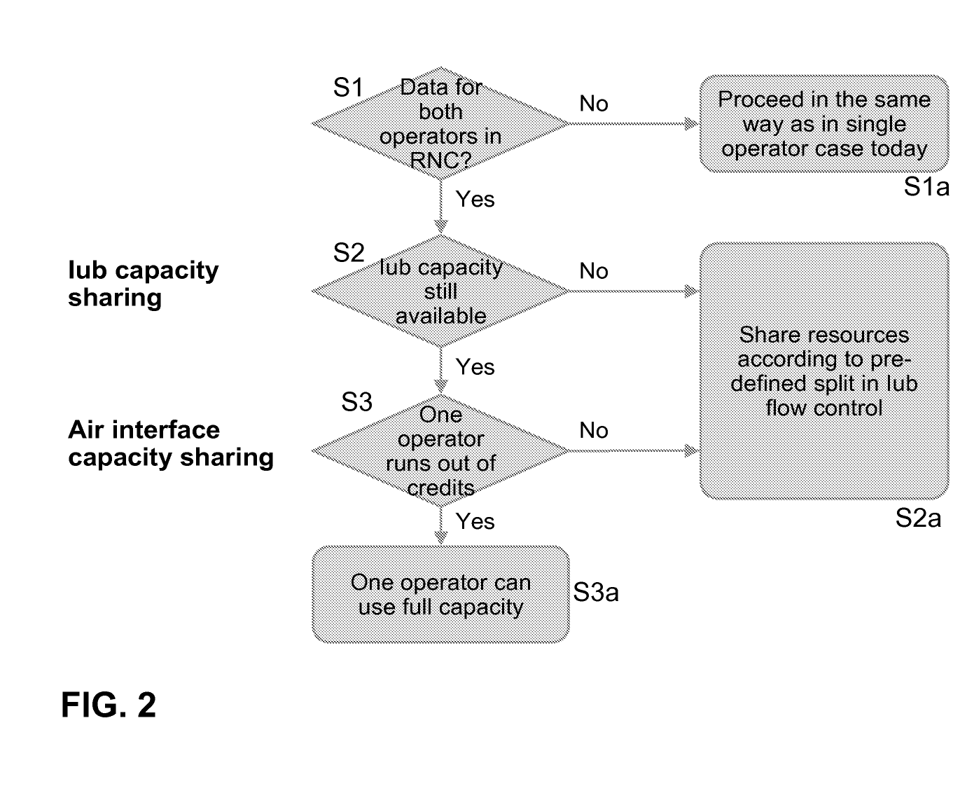

The mobile station UE1 is a subscriber to a first mobile network operator MNO1, whereas the mobile stations UE2 and UE3 are subscribers to a second, different, mobile network operator MNO2. The mobile stations UE2 and UE3 could belong to roaming users, for example. In order to ensure that the mobile stations UE1, UE2 and UE3 subscribing to both operators MNO1 and MNO2 are able to use the resources of the RAN after they have established respective connections with the RAN, the RNC 2 runs a flow control algorithm in the processor of the flow control unit FC, which is illustrated in FIG. 2.

In step S1, it is first determined whether the RNC 2 has data for both operators MNO1 and MNO2. If the RNC 2 does not have data for both operators MNO1 and MNO2, but only for one operator, e.g. MNO1, it proceeds with allocating resources as normal to the single operator MNO1 in step S1a. However, if the RNC 2 has data for both operators MNO1 and MNO2, it checks in step S2 if capacity is still available on the Iub interface for both operators MNO1 and MNO2. If it is determined that no capacity is available on the Iub interface for both operators MNO1 and MNO2, in step S2a it shares resources between the respective connections established between the mobile stations UE1, UE2 and UE3 and the RAN according to a pre-defined split.

How resources are split between the established connections (mobile stations subscribing to the different operators) may be determined in several different ways.

In a preferred embodiment, the resources are shared between the established connections the mobile stations UE1, UE2 and UE3 have with the network according to a pre-defined split in Iub flow control. In this case, the congestion status of the Iub interface is input into the flow control algorithm run on the flow controller FC of the RNC 2. The algorithm checks in Step S2 whether capacity is still available on the Iub interface for the established connections between the network and the mobile stations UE1, UE2 and UE3 belonging to the respective operators MNO1 and MNO2. If capacity is not available, in step S2a resources are split between the established connections according to a pre-defined share in Iub interface flow control, so that the mobile operators MNO1 and MNO2 each get a share of the Iub interface resources. In this example, the Iub interface resources are split 50:50 between the mobile operators MNO1 and MNO2.

The pre-defined share is determined according to the flow control algorithm and could correspond to a pre-defined split in Iub interface throughput, or according to an amount of data to be sent to the mobile stations that has been buffered in the NodeB 1. The pre-defined share of Iub flow control could also be agreed in advance by the mobile network operators MNO1 and MNO2.

In a further enhancement to this embodiment, if during step S2 it is determined that there is still capacity on the Iub interface, credits for each mobile operator MNO1 and MNO2 are input to the Iub flow control algorithm in the flow controller FC of the RNC 2. It is then determined in Step S3 whether the operator MNO1, MNO2 has run out of credits, in other words has no data buffered in the NodeB 1. If the operator MNO1, MNO2 has not run out of credits, resources are shared among the established connections between the respective mobile stations UE1, UE2 and UE3 subscribing to the operators MNO1 and MNO2 and the network according to a pre-defined split in Iub control, as in Step S2a. However, if it is determined in Step S3 that one of the operators has run out of credits, for example MNO2, only the other operator MNO1 can use the full capacity of the air interface of the RAN in Step S3a.

In another embodiment, the resources are shared between established connections between the mobile stations UE1, UE2 and UE3 and the network by limiting the data throughput per mobile operator. This means that the mobile station UE1 belonging to the operator MNO1 would have a limited data throughput (limited Mbps) for its established connection with the network. The mobile stations UE2 and UE3 belonging to the network MNO2 then also have a limited data throughput for their respective established connections with the network. The data rate or data throughput may either be limited by the RNC 2 or by the core network.

In a further embodiment, a pre-determined share of resources is assigned in the NodeB 1. If there is data in the buffer of the NodeB 1 for both operators MNO1 and MNO2 during a particular TTI, the resources of the NodeB 1 (i.e., codes and power) are split between the operators MNO1 and MNO2 according to how much data each operator has in the buffer. For example, if the operators MNO1 and MNO2 each have equal amounts of data in the buffer for the established connections between the network and the mobile station UE1, and mobile stations UE2 and UE3, respectively, the resources of the NodeB 1 are split equally between the two operators MNO1 and MNO2 so that each get 50%. However, the resources of the NodeB 1 may be split between the two operators MNO1 and MNO2 according to any other ratio corresponding to the relative amount of data each operator has in the buffer. If only one operator, for example MNO1, has data in the buffer, then the users of this operator; i.e., the mobile station UE1, will take all the capacity of the NodeB 1.

Although the invention has been described hereinabove with reference to specific embodiments, it is not limited to these embodiments, and no doubt further alternatives will occur to the skilled person, which lie within the scope of the invention as claimed.

1. A method of allocating resources in a communications network to mobile stations belonging to a group, the method comprising
determining whether capacity is available in the network for established connections between the mobile stations and the communications network; and
splitting said resources according to a pre-determined share such that said established connections receive the pre-determined share of said resources if it is determined that the capacity is not available for said established connections.

2. The method according to claim 1, wherein the resources are split according to the pre-determined share on an interface between two nodes of the network.

3. The method according to claim 2, wherein the pre-determined share of the resources corresponds to a pre-defined split in interface throughput.

4. The method according to claim 3, wherein the pre-determined share of said resources is determined according to a flow control algorithm.

5. The method according to claim 4, wherein the pre-determined share of said resources is determined according to whether an amount of data to be sent to the mobile stations has been buffered in a network node.

6. The method according to claim 1, wherein the pre-determined share of the resources corresponds to a share in data throughput in the network

7. The method according to claim 6, wherein the step of splitting comprises limiting the throughput per group in a control node of the network.

8. The method according to claim 6, wherein the step of splitting comprises limiting the throughput per group in a core network part of the network.

9. The method according to claim 1, wherein the pre-determined share of the resources is split in a network node.

10. The method according to claim 1, wherein the group of mobile stations is subscribed to a particular network operator.

11. The method according to claim 1, wherein the group of mobile stations comprises roaming users of the communications network.

12. A control node for a communications network, comprising a processor configured to determine whether capacity is available in the network for established connections between mobile stations belonging to a group and the communications network and to split a pre-determined share of resources and give the pre-determined share to said established connections if it is determined that the capacity is not available for said established connections.

13. The control node according to claim 12, wherein the processor is further configured to calculate the pre-determined share of the resources using a control algorithm.

14. The control node according to claim 12, further comprising a flow control unit configured to control a flow control over an interface between the control node and a network node such that the pre-determined share of the resources to the established connections corresponds to a split in interface throughput.
